(19) United States
(12) Patent Application Publication
(10) Pub. No.: US 2007/0292677 A1
(43) Pub. Date: Dec. 20, 2007

(54) Beaded Coating Compositions

(75) Inventors: Paul M. Kayima, Strongsville, OH (US); James M. Cameron, Brunswick, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 11/424,675

(22) Filed: Jun. 16, 2006

(51) Int. Cl. B32B 27/20

(52) U.S. Cl. 428/323; 428/411.1; 428/327; 428/522

(57) ABSTRACT

The present invention is a coating composition comprising at least one type of bead material in a dispersion medium, wherein the dispersion medium can be an aqueous or non-aqueous-based dispersion.

This invention is also directed to a coated surface comprising a two-layer coating system comprising a topcoat and an undercoat, wherein the topcoat is an aqueous or non-aqueous dispersion comprising at least one type of bead material; and wherein the undercoat is a waterborne dispersion comprising one or more highly water-absorbent pigments.

This invention is also directed to a process for achieving an aesthetic appearance on a surface utilizing a beaded topcoat applied over an undercoat comprising one or more highly water-absorbent pigments.

The present invention is directed to a coating composition for decorative faux finish applications, wherein the coating composition comprises (a) a topcoat comprising at least one type of bead material and (b) an undercoat comprising one or more highly water-absorbent pigments. This invention is also directed to a method of preparing coating compositions comprising (a) applying an undercoat layer comprising one or more highly water-absorbent pigments, and then (b) applying a topcoat layer over the undercoat layer, wherein the topcoat comprises at least one type of bead material.

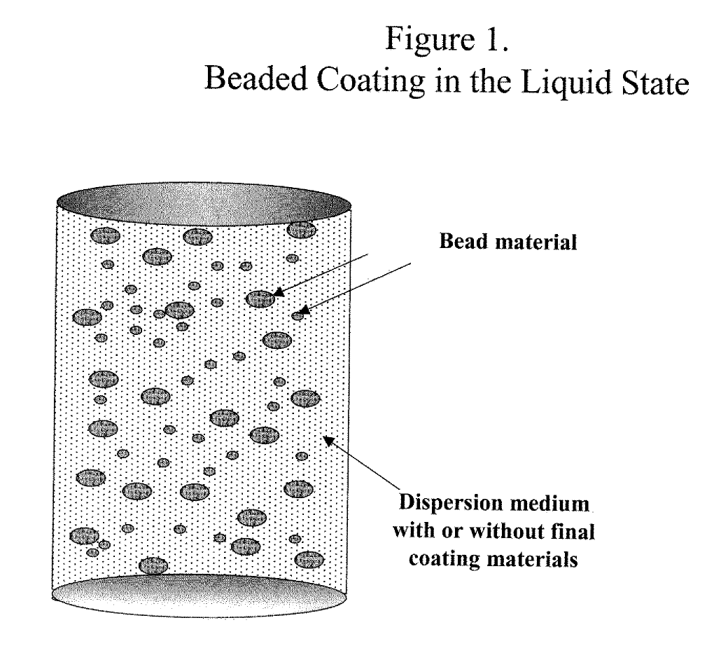

FIG. 1 is a graphical representation showing the beaded coating in the liquid state.

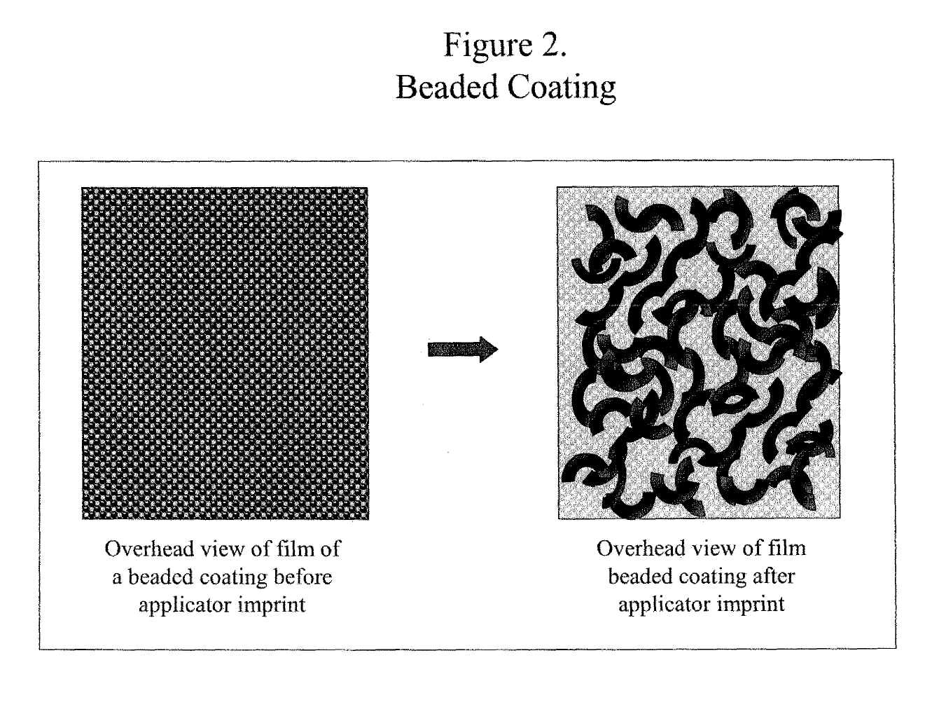

FIG. 2 is a graphical representation of the beaded coating of this invention before and after applicator imprint.

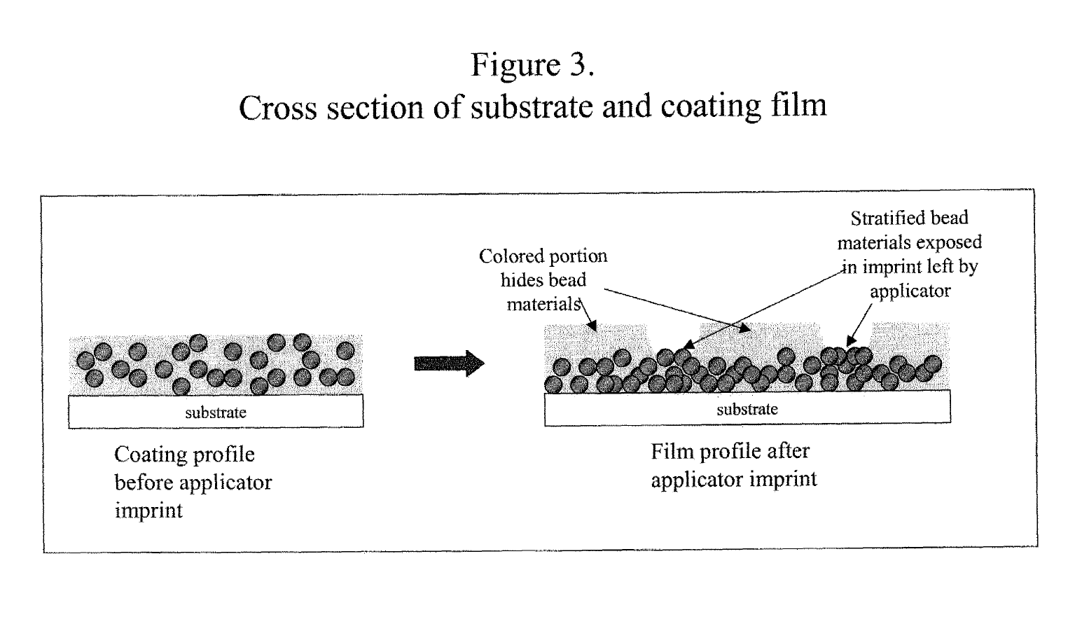

FIG. 3 is a graphical representation of a cross-section of the beaded coating on a substrate before and after an applicator imprint.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

According to this invention, the topcoat comprises one or more bead materials, having particles of sufficient size to be readily visible and produce a desirable color contrast to the naked eye. The bead material(s) can be selected from one or more of the group consisting of polyurethane, polyvinyl chloride, polypropylene, polyethylene, synthetic rubber, natural rubber, polystyrene, polyurea, and polyacrylic. The bead material(s) can have a mean particle size range of 30 to 600 microns. For example, in one embodiment, the bead material has a mean particle size in the range of 80 to 200 microns.

The bead materials can be dispersed in an aqueous or non-aqueous medium of a color the same as or different from that of the topcoat dispersion phase. Such bead particles provide the desirable color contrast and are readily visible to produce a faux finish product, which is an objective of the invention.

The bead materials are dispersed in an aqueous or non-aqueous medium to produce a desired bead topcoat dispersion. Examples of aqueous-based dispersions include, but are not limited to, water, latex emulsions, polyurethane dispersions, water-based alkyd (or alkyds modified with acrylic, urethane or styrene) emulsions, dispersions and solutions; water-based acrylic dispersions and solutions. By way of example, some latices useful for this invention include, but are not limited to, Joncryl SCX2577 (commercially available from S.C. Johnson, Racine, Wis.), UCAR 471 or UCAR 461 (both commercially available from Dow Chemical), styrene-acrylic, and SC-10 (commercially available from Rohm & Haas Company). The mode of dispersion can include but not limited to, stirring, shaking, agitation with a blade, milling, and sonication. The amount of bead materials present in the dispersion can be from about 2.5 weight percent up to about 75 weight percent, based on the total topcoat formulation weight, and generally in the range of between 15 weight percent to 30 weight percent, based on the total topcoat formulation weight. The topcoat can comprise a colorant having a color different than the bead material whereby an aesthetic appearance is effectuated.

The dispersion stability, aesthetic appearance, and integrity of the final coating film may depend on the following variables:

1) Size distribution, shape, and chemistry of the bead material(s) (type and ratios);

2) composition, color, and opacity of the dispersion medium; and

3) ratio of the bead material(s) to the dispersion medium.

Thus, such variables can be varied accordingly to achieve a desired effect,

The coating composition can be easily formulated with other typical raw materials as needed to obtain desired application, stability, appearance, and performance properties. These include materials such as water, coalescing agents, humectants, co-binder, pigment slurries. colorants, rheology modifiers, amines, mildewcides and biocides.

One embodiment of this invention is a two-layer coating system comprising a topcoat, wherein the topcoat is an aqueous or non-aqueous dispersion comprising the bead material(s), and an undercoat, wherein the undercoat comprises a highly water absorbing pigment. The undercoat of this invention should have a pigment volume concentration of at least 55, and can be between 55 and 80 or between 65 to 75. The pigment utilized in the undercoat can be any highly water absorbent pigment that is water insoluble, including by way of nonlimiting example, aluminum silicate and calcium carbonate.

The two-layer coating system is applied to obtain a beaded coating on a surface of a substrate by:
a. applying an undercoat, wherein the undercoat is a waterborne dispersion comprising one or more highly water absorbent pigments;
b. applying a topcoat over the undercoat wherein the topcoat comprises at least one type of bead material.

The undercoat and/or topcoat can be applied to the surface using brush, drawdown, roller, spray application, or any other method of the art, and allowed to dry.

The present invention has the special advantage of achieving different aesthetic desirable effects and patterns. The coating compositions of this invention can be applied to essentially any surface that is amenable to conventional coating techniques, by spray, roller, brush, or other applicators. Striking patters can be made utilizing a variety of applicators. When the tinted coating composition is applied multi-directionally using an applicator providing a textured result, the coating develops a random pattern in which areas of varying film thickness display shades of varying color and sheen. As the coating is applied, the bead dispersion is preferentially stamp-deposited onto the substrate surface, resulting in layering or stratification of the bead color and the tinting color of the emulsion phase. As a consequence, in a textured coating, the thinner regions of the coating display more of the bead color, while the thicker areas exhibit more of the tinting color. Thus, faux patterns can comprise randomly distributed domains of two or more colors and any color combinations of these colors can be made.

### EXAMPLE 1

The following example illustrates a formulation of a topcoat composition utilizing bead materials, in accordance with this invention.

| Add in order under mild agitation | By weight |
|---|---|
| Polyurethane beads (Decosphaera D. Blk 30 | 23.1 |
| available from SuperColori S.p.A., Italy) | |
| Latex | 46.2 |
| Water | 19.6 |
| HASE Thickener | 4.4 |
| White colorant (BAC from Degussa) | 4.4 |
| Texanol (ester alcohol) | 2.2 |
| Total | 100.0 |
| % non-volatile by weight | 48% |

### EXAMPLE 2

The undercoat can be formulated by adding the following ingredients:

| Add the following in order under mild agitation | By weight |
|---|---|
| Ethylene vinyl acetate latex emulsion | 13.61 |
| Water | 3.03 |
| Ethylene glycol | 0.69 |
| Defoamer | 0.07 |
| Benzoisothiazolinone in-can preservative | 0.04 |
| 2-Amino-2-methyl-1-propanol (Angus AMP-95) | 0.15 |
| Nonionic surfactant | 0.48 |
| Anionic surfactant | 0.32 |
| Aluminum silicate (clay) slurry | 79.93 |
| Ethylene glycol butyl ether | 1.28 |
| 50% solution HASE thickener | 0.38 |
| Total | 100 |
| PVC | 73.70 |
| non-volatile by weight | 61.80 |
| weight (pounds) per gallon | 12.6 |

1. A two-layer coating system comprising a topcoat and an undercoat, wherein the topcoat is an aqueous or non-aqueous dispersion comprising at least one type bead material;
and wherein the undercoat is a waterborne dispersion comprising one or more highly water-absorbent pigments.

2. The composition of claim 1, wherein the bead material has a mean particle size ranging of 30 to 600 microns.

3. The composition of claim 1, wherein the bead material has a mean particle size in the range of 80 to 200 microns.

4. The composition of claim 1, wherein the topcoat comprises a colorant having a color different than the bead material whereby a aesthetic appearance is effectuated.

5. The composition of claim 1, wherein the undercoat has a pigment volume concentration (PVC) of at least 55.

6. The composition of claim 1 wherein the PVC of the undercoat is between 55 and 80 for the total undercoat formulation.

7. The composition of claim 1 wherein the PVC of the undercoat is in the range of 65 to 75.

8. The composition of claim 1, wherein the bead material can be selected from the group consisting of polyurethane, polyvinyl chloride, polypropylene, polyethylene, synthetic rubber, natural rubber, polystyrene, polyurea, and polyacrylic.

9. The composition of claim 1, wherein the bead material is present in the range of 2.5 weight percent to 75 weight percent based on total topcoat formulation weight.

10. The composition of claim 1, wherein the bead material is present in the range of 15 weight percent to 30 weight percent based on total topcoat formulation weight.

11. The composition of claim 1 wherein the topcoat has a non-volatile materials content in the range of 15 to 75%.

12. The composition of claim 1 wherein the topcoat has a non-volatile materials content in the range of 35 to 50%.

13. The composition of claim 1 wherein the highly water-absorbing pigment is selected from aluminum silicate and calcium carbonate.

14. The composition of claim 1 wherein the highly water-absorbing pigment is aluminum silicate (clay).

15. A method of obtaining a aesthetic coating on a surface comprising applying a two-layer coating system comprising a topcoat and an undercoat, wherein the topcoat is an aqueous or non-aqueous dispersion comprising at least one type of bead material; and wherein the undercoat is a waterborne dispersion comprising one or more highly water-absorbent pigments.

16. The method of obtaining a aesthetic coating on a surface comprising:
a. applying an undercoat, wherein the undercoat is a waterborne dispersion comprising one or more highly water absorbent pigments;
b. applying a topcoat over the undercoat wherein the topcoat is an aqueous or non-aqueous dispersion comprising at least one type of bead material; and wherein the undercoat is a waterborne dispersion comprising one or more highly water-absorbent pigments.

17. The method of claim 19 wherein the undercoat or topcoat is applied to a surface using brush, drawdown, roller, or spray application, and allowed to dry.

18. A coated surface comprising a two-layer coating system comprising a topcoat and an undercoat, wherein the topcoat is an aqueous or non-aqueous dispersion comprising at least one type of bead material; and wherein the undercoat is a waterborne dispersion comprising one or more highly water-absorbent pigments.
